(19) United States
(12) Patent Application Publication
(10) Pub. No.: US 2022/0266563 A1
(43) Pub. Date: Aug. 25, 2022

(54) WICKET BAG

(71) Applicant: LEMO MASCHINENBAU GMBH, Niederkassel-Mondorf (DE)

(72) Inventors: Bernd SCHLARP, Troisdorf (DE); Hartmut ODENTHAL, Troisdorf (DE)

(21) Appl. No.: 17/769,743

(22) PCT Filed: Nov. 9, 2020
(86) PCT No.: PCT/EP2020/081533

§ 371 Date: May 9, 2022

(30) Foreign Application Priority Data
Nov. 11, 2019 (DE) 10 2019 130 401.6

(51) Int. Cl. B31B 70/62; B31B 70/26; B31B 70/98

(52) U.S. Cl. CPC B31B 70/62; B31B 70/262; B31B 70/984; B31B 2155/0014

(57) ABSTRACT

The invention relates to a method for producing a bag, in which method a bag is produced from a fiber material, preferably a paper material, wherein a web made of the fiber material, preferably a paper web, is unwound as a flat web, thereafter sequential adhesive strips are applied in continuous operation, thereafter the flat web is folded to form a bag shape, thereafter the adhesive strips are activated, for connection, by the application of heat, and thereafter individual bags are cut from the flat web by means of a cutting device.

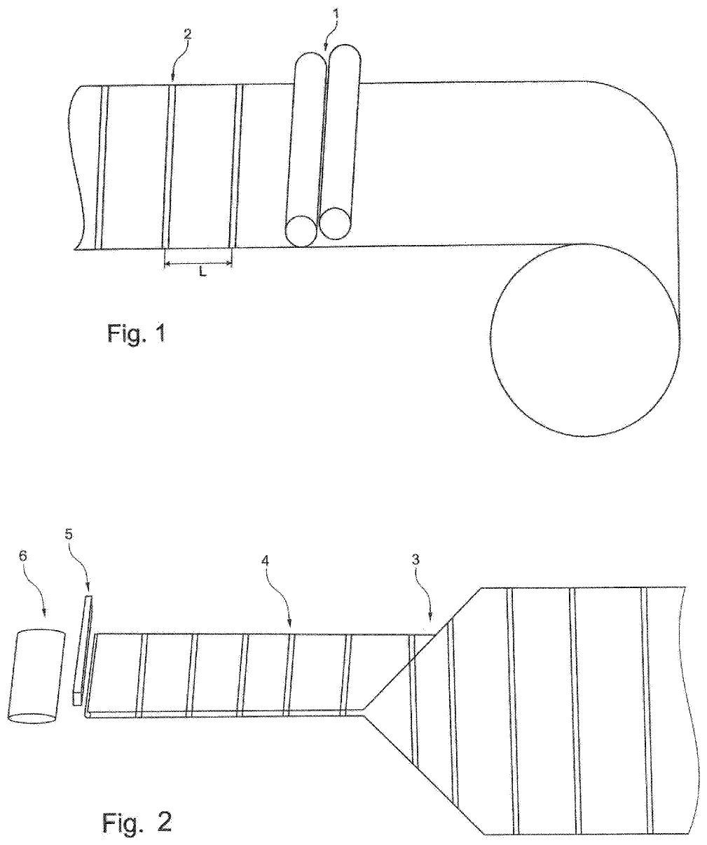

The invention relates to a method of making a bag, in particular a wicket bag for hygiene articles or for sanitary napkins, diapers and the like.

Such bags, in particular wicket bags, are made in practice from plastic. Plastics of this type are problematic in terms of their disposal, since, if at all, they only rot after many years when composted. Although thermal destruction by combustion is possible, it is not sustainable.

The object of the invention is to improve such bags, in particular wicket bags, with respect to sustainability and to provide a method of making such bags.

This object is achieved in that the bag is made from a fibrous material, preferably paper in that a web of the fibrous material, preferably a paper web, is unwound as a flat web, thereafter, in a continuous operation, sequential adhesive strips, preferably adhesive strips or PE strips, are applied {laminated onto), then the flat web is folded to form a sleeve, preferably of a wicket bag, and then heat is applied, in particular by welding bars, to activate the adhesive strips, in particular the adhesive or the PE strips, and connect them together, and finally individual bags are separated from the flat web by a cutting device, preferably a knife.

In the case of wicket bags, but also in other types of bags, the bags can be provided with at least one already known hole (before or after separation from the flat web) in order to deposit them and form them into a stack on at least one corresponding pin.

The sequential adhesive strips are applied, for example, by a method as described in DE 40 31 984. The printing cylinder described there for printing is used to apply a suitable adhesive that forms the sequential adhesive strips to the flat web instead of ink. The rotary printing device for applying small printed images to a material web with a printing plate, counter-pressure body, inking roller and drive is modified to the effect that adhesive strips (instead of ink) are applied to the web of material (flat web) and the inking roller is a roller for applying adhesive. In this modified rotary adhesive applicator, the drive of the printing plate has a speed-controlled drive motor connected to a computer controller whose drive speed can be regulated according to a rotational speed control function stored in the computer control as a function of the angular position of the plate base body passing through the range from 0° to 360°. The rotational speed control function is defined in such a way that, in a first angular range, the circumferential speed of the plate base body corresponds to the circumferential speed of the adhesive application roller, in a second angular range the circumferential speed of the plate base body corresponds to the feed speed of the material web and, outside the two angular ranges, there are acceleration and deceleration phases with respect to the rotational movement of the plate base body that can be adjusted independently of the feed movement of the material web in accordance with the spacing between successive adhesive strips.

The course of a manufacturing method according to the invention, for which purpose the device described above can be used (but does not have to be used, since differently operating devices with the same aim for making improved bags can be used), is shown in the drawing.

An adhesive, preferably adhesive strip, is applied to the schematically illustrated flat web of a fiber material that is preferably recyclable or alternatively compostable, as a feed-dependent strip 2 on the flat web. This is followed by folding of the flat web at 3 to form a two-layer preform 4. Strips can preferably be applied to both faces of two-layer preform 4 (but application to only a single face could also be considered) and is fed to an activation and/or welding station 5. In the case of the activation station, the latter is designed for heat generation, in that the thermal treatment (heat) generated there acts activates the applied adhesive. This is followed by deposition of the bags at 6.

### LIST OF REFERENCE SIGNS

1 Rotary applicator
2 Strips applied to the flat web
3 Folding the flat web to the two-layer preform
4 Opposite application two-layer preform
5 Activation/welding station
6 Bag deposition

1. A method of making a bag of making a bag of a fibrous material, the method comprising the steps of sequentially:
providing a flat web of the fibrous material, preferably a paper web,
applying a plurality of spaced adhesive strips to at least one face of the web,
folding the flat web with the strips to form a half sleeve,
activating the adhesive strips are activated by heat action to adhere the half sleeve together, and
cutting individual bags from the flat web.

2. The method according to claim 1, wherein the adhesive strips or PE strips are applied and activated as sequential adhesive strips.

3. The method according to claim 1, wherein the flat web is folded to form a wicket bag.

4. The method according to claim 1, 2, wherein the action of heat is realized by welding bars.

5. The method according to claim 1, 2, wherein individual bags are cut from the flat web by a knife.

6. A method of making a bag, the method comprising the steps of sequentially:
providing a flat compostable and longitudinally extending web;
providing on a face of the web a plurality of longitudinally spaced and transversely extending full-width strips of heat-activatable adhesive;
folding the web bearing the strips along a longitudinal centerline to form an upper layer and a lower layer with the strips between the layers and fold the strips over on themselves;
heat activating the strips to bond the layers together at the strips; and
subdividing the web at the strips to form the bags.
